(19) United States
(12) Patent Application Publication
(10) Pub. No.: US 2006/0132520 A1
(43) Pub. Date: Jun. 22, 2006

(54) Multiple-function inkjet printing system with single motor for carriage and scan head motion

(76) Inventors: James Daren Bledsoe, Albany, OR (US); Gregory Frank Carlson, Corvallis, OR (US); Jerry A. Marshall JR., Corvallis, OR (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/013,820

(22) Filed: Dec. 16, 2004

(51) Int. Cl. B41J 29/38

(52) U.S. Cl. 347/12

(57) ABSTRACT

A multiple-function inkjet printing system includes a media transport assembly which routes a print medium through the inkjet printing system, a carriage assembly which holds an inkjet print head assembly and traverses the print medium, a scan assembly connected to the carriage assembly which holds a scan head and traverses a scan medium, and a single motor operatively coupled to the carriage assembly. As such, the single motor drives both the carriage assembly and the scan assembly.

### BACKGROUND OF THE INVENTION

The present invention relates generally to inkjet printers, and more particularly to a multiple-function inkjet printing system using a single motor for carriage and scan head motion.

A conventional inkjet printing system includes a print head and an ink supply which supplies liquid ink to the print head. The print head, commonly referred to as a pen, ejects ink drops through a plurality of orifices or nozzles toward a print medium, such as a sheet of paper, so as to print onto the print medium. Typically, the orifices are arranged in one or more arrays such that properly sequenced ejection of ink from the orifices causes characters or other images to be printed upon the print medium as the print head and the print medium are moved relative to each other. The nozzles are typically arranged in linear arrays usually located side-by-side on the print head, parallel to one another, and perpendicular to the scanning direction of the print head, with the length of the nozzle arrays defining a print swath or band. That is, if all the nozzles of one array were continually fired as the print head made one complete traverse through the print-zone, a band or swath of ink would appear on the print media. The width of this band is known as the “swath height” of the pen, the maximum pattern of ink which can be laid down in a single pass. The print media, such as a sheet of paper, is moved through the print zone typically one swath width at a time as the print head moves back and forth over the print media. Some print schemes move the media incrementally by, for instance, halves or quarters of a swath width for each print head pass to obtain a layered drop placement which enhances the appearance of the final image.

Recognizing that various office machines share common functionality, the trend in the industry is towards multiple-function, or “all-in-one” office systems. These systems typically include a print functionality, described above, a scan functionality, a copy functionality (which combines a scan and a print), and often a fax functionality (which incorporates a transmit/receive unit and utilizes the scan functionality for fax sends and the print functionality for fax receives).

Multiple-function inkjet printing systems that include scanners provide a scan head with image receptors that “read” an image previously printed on a scanned media and convert this image into an electronic file which may then be computer edited, or sent to a selected destination over a network, via electronic mail (E-Mail), or facsimile transmitted over telephone lines, or printed for instance. The image receptors in a scan head may be a series of discrete elements arranged in a linear array.

FIG. 1 illustrates a conventional multiple-function inkjet printing system 2. As shown, multiple-function inkjet printing system 2 includes a print media transport assembly 10 which moves and/or routes a print medium 4 through a print media path, a carriage assembly 20 which moves a carriage 22 holding a print head 26 relative to the print medium 4, a scan assembly 30 which moves a scan head 32 relative to the scan medium 6 held in place on a platen 7, and a service station assembly 40 which maintains functionality of the print head 26.

The print media transport assembly 10 typically includes a paper pick-up assembly 12 which brings the print medium 4 into the printing system, a drive or feed roller assembly 14 which advances the print medium 4 through the printing system, and a print path motor 16 which operates the paper pick-up assembly 12 and the feed roller assembly 14.

The carriage assembly 20 typically includes a carriage 22 which carries the print head 26 and a carriage motor 24 which operates the carriage. The print head 26 holds the nozzles 27 relative to the print medium 4 for printing a print swath within the print zone 28 of the print medium 4. The scan assembly 30 typically includes a scan head 32 which includes a plurality of image receptors 36 and a scan head motor 34 which operates transport of the scan head 32. The scan head 32 holds the image receptors 36 relative to the scan medium 6 for scanning within the scan zone of the scan medium 6. Furthermore, the service station assembly 40 typically includes a service station motor 42 which operates functions of the service station assembly, including removal and replacement of the pen caps, and wiping the pen nozzles.

FIG. 2 illustrates a method 50 of operation of the conventional multiple-function inkjet printing system for a print/scan/copy job. Referring to FIG. 2, at step 51, the multiple-function inkjet printing system gains operational control of a print/scan/copy job. If the job includes a print/copy, at step 52 the print head 26 is uncapped and wiped by operation of the service station assembly 40. Operation of the service station assembly 40 in step 52 requires operation of the service station motor 42. Next, if the job includes a print/copy, at step 53, the print medium 4 is pulled into the printing system by operation of the print media transport assembly 10. Operation of the print media transport assembly 10 in step 53 requires operation of the print path motor 16. Next, if the job includes a scan/copy, at step 54, the scan head 32 is moved to a “Ready” position by operation of the scan head assembly 40. Operation of the scan head assembly 40 in step 54 requires operation of the scan head motor 34. Next, if the job includes a print/copy, at step 55, the carriage 22 is moved to a “Ready” position by operation of the carriage assembly 20. Operation of the carriage assembly 20 in step 55 requires operation of the carriage motor 24.

To begin scanning, if the job includes a scan/copy job, the scan head 32 is moved across the scan medium 6 by operation of the scan assembly 30 to scan a scan swath in step 56. Operation of the scan assembly 30 in step 56 requires operation of the scan motor 44.

To begin printing, if the job includes a print/copy job, the print medium 4 is moved into position by operation of the print media transport assembly 10 at step 57. Operation of the print media transport assembly 10 in step 57 requires operation of the print path motor 16. Next, at step 58, the carriage 22 is moved across the print medium 4 by operation of the carriage assembly 20 to print a print swath. Operation of the carriage assembly 20 in step 58 requires operation of the carriage motor 24.

Steps 56, 57, and 58 are repeated as appropriate to the job until the print/scan/copy job is completed.

If the job includes a scan/copy job, once the scan job is completed, the scan head 32 is moved to a “Rest” position by operation of the scan assembly 30 in step 59. Operation of the scan assembly 30 in step 59 requires operation of the scan motor 44.

On a print/copy job, once the print job is completed, the print medium 4 is ejected from the printing system by operation of the print media transport assembly 10 at step 60. Operation of the print media transport assembly 10 in step 60 requires operation of the print path motor 16. Next, at step 61, the carriage 22 is moved to a “Rest” position by operation of the carriage assembly 20. Operation of the carriage assembly 20 in step 61 requires operation of the carriage motor 24. Finally, at step 62, the print head 26 is wiped and capped by operation of the service station assembly 40. Operation of the service station assembly 40 in step 62 requires operation of the service station motor 42.

Operation of the conventional inkjet printing system, therefore, requires operation of multiple motors. More specifically, operation of the conventional multiple-function inkjet printing system requires operation of paper path motor(s), a carriage motor, a scan head motor, and a service station motor. Unfortunately, for each additional motor included in the multiple-function inkjet printing system, there is added size, complexity, and cost to the system.

Efforts to reduce the number of motors required in inkjet printing systems include U.S. Pat. No. 6,533,387 to Simmons et al., issued on Mar. 18, 2003 and entitled “Inkjet Printing System Using Single Motor For Print Media Advance And Carriage Motion”, the entire disclosure of which is incorporated herein by reference. In the '387 patent, print paper transport, carriage operation, and service station operation are all actuated under control of a single motor.

U.S. Pat. No. 6,561,618 to Simmons et al., the entire disclosure of which is incorporated herein by reference, describes a two-motor printer solution that uses one motor for carriage motion and another motor for both paper advance and service station functions.

However, no clear solution as yet exists for reducing the number of motors and media positioning components in a multiple-function printing system which requires print and scan/copy capability. Accordingly, a need exists for a multiple-function printing system which is smaller or performs more functions for the same size, simpler to manufacture, and/or less expensive to manufacture. In particular, a need exits for a multiple-function inkjet printing system which utilizes a single motor to control operation of multiple functions such as moving a print carriage, moving a scan head, advancing a print medium, and/or maintaining a print head.

### SUMMARY OF THE INVENTION

One aspect of the present invention provides a multiple-function inkjet printing system. The multiple-function inkjet printing system includes a media transport assembly adapted to route a print medium through the inkjet printing system, a carriage assembly adapted to hold an inkjet print head and traverse the print medium, a scan assembly adapted to hold a scan head and traverse the scan medium, and a service station assembly adapted to service and maintain the print head assembly. A single motor is adapted to drive both the carriage assembly and the scan assembly.

In one embodiment, the scan head assembly is fixedly attached to the carriage assembly, resulting in simultaneous linked operation of motion of the carriage and scan head. In another embodiment, the scan head assembly is removably attachable to the carriage assembly, allowing for simultaneous linked operation of the scan head and carriage during scan and/or copy operations, yet results in faster printing when a scan operation is not involved in the job.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is schematic illustration of a portion of a prior art multiple-function inkjet printing system;

FIG. 2 is a flow diagram illustrating one embodiment of a method of operating the prior art multiple-function inkjet printing system of FIG. 1;

FIG. 3 is a block diagram illustrating one embodiment of a multiple-function inkjet printing system according to the present invention;

FIG. 4A is a side view of the carriage/scan assembly illustrating a compression coupling mechanism;

FIG. 4B is a cross-sectional top view of the compression link couplable carriage/scan assembly of FIG. 4A when the carriage and scan head are not coupled;

FIG. 4C is a cross-sectional top view of the compression link couplable carriage/scan assembly of FIG. 4A when the carriage is beginning to engage the scan head;

FIG. 4D is a cross-sectional top view of the compression link couplable carriage/scan assembly of FIG. 4A when the carriage is engaged with the scan head;

FIG. 4E is a cross-sectional top view of the compression link couplable carriage/scan assembly of FIG. 4A when the carriage is engaged with the scan head and moving in a first direction;

FIG. 4F is a cross-sectional top view of the compression link couplable carriage/scan assembly of FIG. 4A when the carriage is engaged with the scan head and moving in a second direction;

FIG. 4G is a cross-sectional top view of the compression link couplable carriage/scan assembly of FIG. 4A when the carriage is beginning to disengage from the scan head;

FIG. 4H is a cross-sectional top view of the compression link couplable carriage/scan assembly of FIG. 4A when the carriage is disengaged from the scan head; and

FIG. 5 is a flow diagram illustrating one embodiment of a method of operating an inkjet printing system according to the present invention.

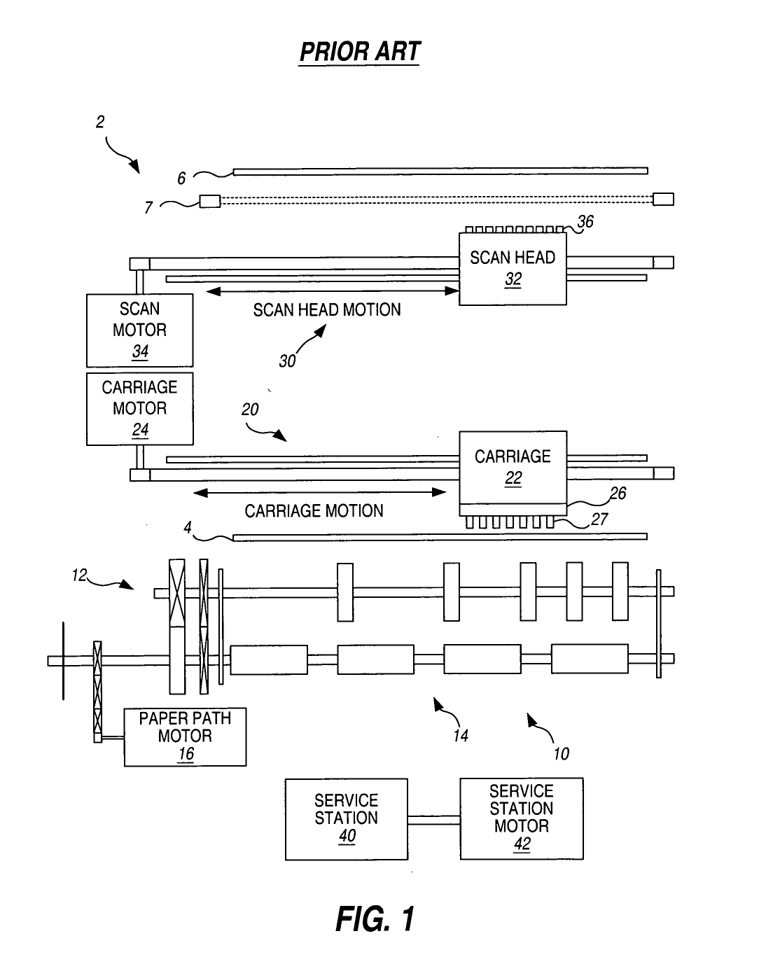

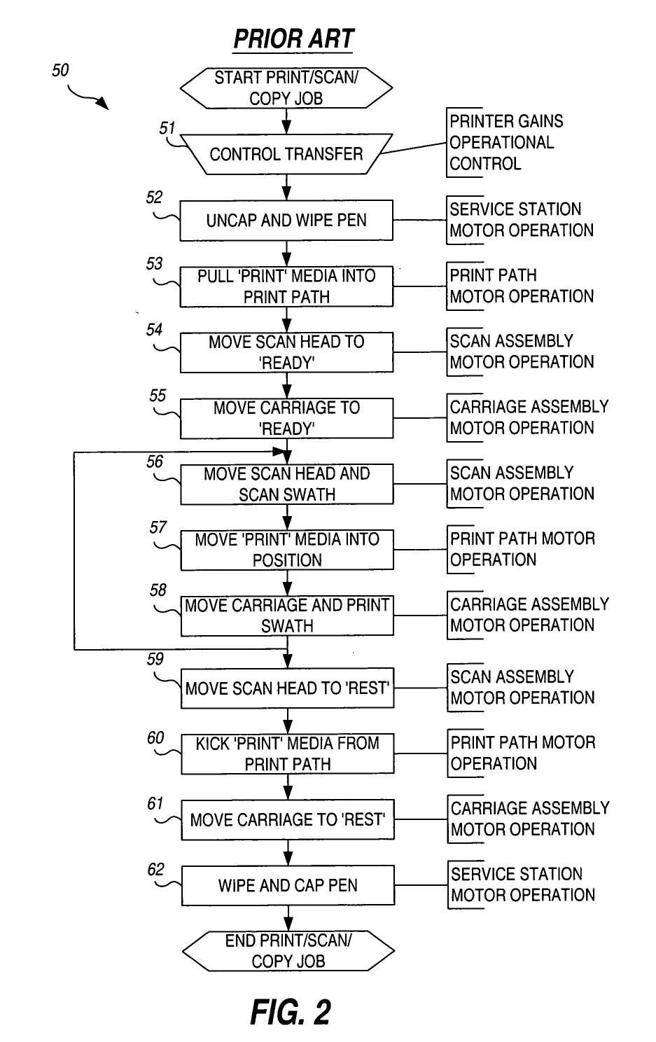

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “right,” “left,” “forward,” “reverse,” etc., is used with reference to the orientation of the Figure(s) being described. The multiple-function inkjet printing system and related components of the present invention can be positioned in a number of different orientations. As such, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

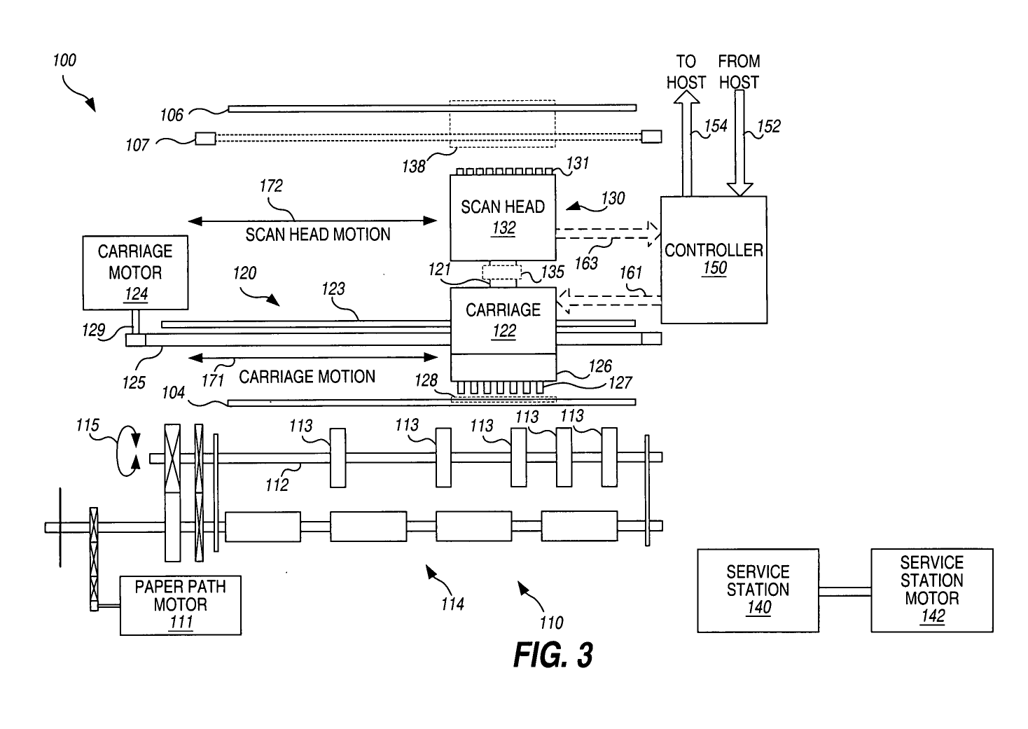

FIG. 3 illustrates one embodiment of a multiple-function multiple function inkjet printing system 100 according to the present invention. Multiple-function multiple function inkjet printing system 100 includes a media transport assembly 110, a carriage assembly 120, a scan assembly 130, a service station assembly 140, and a controller 150.

In one embodiment, media transport assembly 110 includes a shaft 112 and one or more rollers 113. Shaft 112 is mounted in a housing (not shown) of multiple function inkjet printing system 100 for rotational movement, as indicated by bidirectional arrow 115. Rollers 113 are mounted on shaft 112 to contact and route print medium 104 through a print media path of multiple function inkjet printing system 100. As such, rollers 113 advance print medium 104 relative to carriage 122 in a direction substantially perpendicular to the direction of motion of carriage 122. Print media transport assembly 110 also includes a print paper pick-up mechanism 114 which initially engages a top sheet of print medium 104 and routes print medium 104 to rollers 113.

Carriage assembly 120 includes one or more print heads 126 which eject drops of ink through a plurality of orifices or nozzles 127 and toward a print medium 104 so as to print onto print medium 104. Print medium 104 is any type of suitable sheet material, such as paper, card stock, transparencies, Mylar, cloth, and the like. Typically, nozzles 127 are arranged in one or more columns or arrays such that properly sequenced ejection of ink from nozzles 127 causes characters, symbols, and/or other graphics or images to be printed upon print medium 104 as print head 126 and print medium 104 are moved relative to each other.

Ink is supplied to the print head assembly 126 using any of various standard methods. In one embodiment, the print head 126 and ink supply are housed together in an inkjet cartridge or pen. In another embodiment, the ink supply is separate from inkjet print head 126, which receives ink through an interface connection, such as a supply tube.

Carriage assembly 120 positions the print head 126 relative to print media transport assembly 110 and print media transport assembly 110 positions print medium 104 relative to print head 126. Thus, a print zone 128 is defined adjacent to nozzles 127 in an area between print head 126 and print medium 104.

In one embodiment, carriage assembly 120 includes a shaft 123 and a carriage 122. Shaft 123 is mounted in a housing (not shown) of the multiple-function multiple function inkjet printing system 100 and provides a guide for carriage 122. Carriage 122 carries print head 126 and is slidably mounted on shaft 123 for lateral movement, as indicated by bidirectional arrow 171. A power transmission arrangement includes a power transmission element 129, such as a pulley or gear, to transfer rotational power of motor 124 to a reciprocating element 125, such as a belt or chain, coupled with carriage 122. Thus, power of motor 124 is transferred to power transmission element 129 and reciprocating element 125, and reciprocating element 125, therefore, imparts lateral motion to carriage 122. As such, carriage 122 moves print head 126 back and forth across print medium 104.

Service station assembly 140 provides for spitting, wiping, capping, and/or priming of print head 126 in order to maintain a functionality of the print head and, more specifically, nozzles 127. In one embodiment, service station assembly 140 includes a spittoon (not shown) into which print head 126 ejects ink to insure an appropriate level of pressure and fluidity is maintained and that nozzles 127 do not clog or weep. In addition, service station assembly 140 includes a rubber blade or wiper (not shown) which is periodically passed over print head 126 to wipe and clean nozzles 127 of excess ink. Service station assembly 140 also includes a cap (not shown) which covers print head 126 to protect nozzles 127 from drying out during periods of non-use. Functions of service station assembly 140, therefore, require relative motion between service station assembly 140 and the print head 126.

The scan assembly 130 includes a scan head 132 with one or more discrete image receptors 131 which “read” a corresponding image within a corresponding scan zone 138 on a scan medium 106. The scan medium 106 is positioned on a platen 107 made of a transparent material such as glass, plastic, etc. Glass is preferred, of course, for its properties related to optical clarity, higher resistance to scratching, and simple cleaning procedures; however, plastic may also be chosen in less expensive embodiments. Scan medium 106 is any type of suitable sheet material, such as paper, card stock, transparencies, Mylar, cloth, and the like. Typically, image receptors 131 are arranged on the scan head 132 in a linear array, perpendicular to the direction of motion of the scan head in the scan zone. A controller 160 receives a scan signal from the scan head 132, indicative of an image previously recorded on the scan medium 106.

Electronic controller 150 communicates with print head 126, carriage assembly 120, scan assembly 130, print media transport assembly 110, and service station assembly 140. Electronic controller 150 receives data 152 from a host system, such as a computer, and includes memory for temporarily storing data 152. Typically, data 152 is sent to multiple-function inkjet printing system 100 along an electronic, infrared, optical or other information transfer path. Data 152 represents, for example, a document and/or file to be printed. As such, data 152 forms a print job for multiple function inkjet printing system 100 and includes one or more print job commands and/or command parameters. Electronic controller 150 also sends data 154 to the host system along an electronic, infrared, optical or other information transfer path. Data 154 includes one or more print/scan/copy job status and/or status parameters, and image data acquired by the scan assembly 130 from a scanned medium 106.

In one embodiment, electronic controller 150 provides control of print head 126 including timing control for ejection of ink drops from nozzles 127. As such, electronic controller 150 defines a pattern of ejected ink drops which form characters, symbols, and/or other graphics or images on print medium 104. Electronic controller 150 also provides control of scan head 132 including timing control for acquiring image data from image receptors 131. As such, electronic controller 150 defines a pattern of pixels which form characters, symbols, and/or other graphics or images on print medium 106. Timing control and, therefore, the pattern of ejected ink drops within the print zone and/or detected images within the scan zone, is determined by the print/scan/copy job commands and/or command parameters.

Accordingly to the present invention, during scan/copy operations, the carriage 122 and scan head 132 are operatively coupled. Furthermore, carriage motor 124 is operatively coupled with carriage assembly 120 and scan assembly 130. As such, motor 124 operates, drives, or powers each of carriage assembly 120 and scan assembly 130. In the preferred and illustrative embodiment, motor 124 drives the carriage assembly 120, and the operational coupling link between the motor 124 and scan assembly 140 is provided by a mechanical link 121 between the carriage 122 and scan head 132. In one embodiment, the mechanical link 121 is a permanent link, whereby the scan assembly 130 is fixedly and non-removably attached to the carriage assembly 120, and more particularly, the scan head 132 is physically attached to the carriage 122. Thus, any movement on the part of the carriage 122 necessarily results in like movement of the scan head 132. In another embodiment, the carriage 122 and scan head 132 are formed together in one integral unit, where again, any movement on the part of the carriage 122 necessarily results in like movement of the scan head 132. In other embodiments, the mechanical link 121 provides removable attachment functionality, whereby the scan assembly 130 may be attached to the carriage assembly 120 under the control of a controller during scan/copy jobs. In still other embodiments, motor 124 may be selectively transmitted to each of carriage assembly 120 and scan assembly 130.

In any of the described embodiments, scan head 132 is attached to the carriage assembly 120 by way of an attachment link 121. The scan assembly 140 is attached to the carriage 122 in such a position so as to allow the nozzles 127 of the print head 126 to print a swath in the print zone 128 of the print medium 104 and to allow the image receptors 131 of the scan head 132 to scan a swath in the scan zone 138 of the scan medium 106.

In one embodiment, the scan head 142 may be attached to the carriage 122 only during scan/copy operations. In some embodiments, the attachment link 121 may be a mechanical coupling mechanism such as a compression link, a latch, Velcro™, etc., which relies on movement and speed of movement of the carriage to engage and disengage the carriage from the scan head. For example, in this embodiment, during scan/copy jobs, the controller 150 causes the carriage 122 to move to a position in proximity to the scan assembly 130 to engage the coupling mechanism and then to move the scan head 132 over the length of the scan medium 106 to perform the scan functions. When the scan job is complete, the controller 150 causes the carriage 122 to disengage the coupling mechanism.

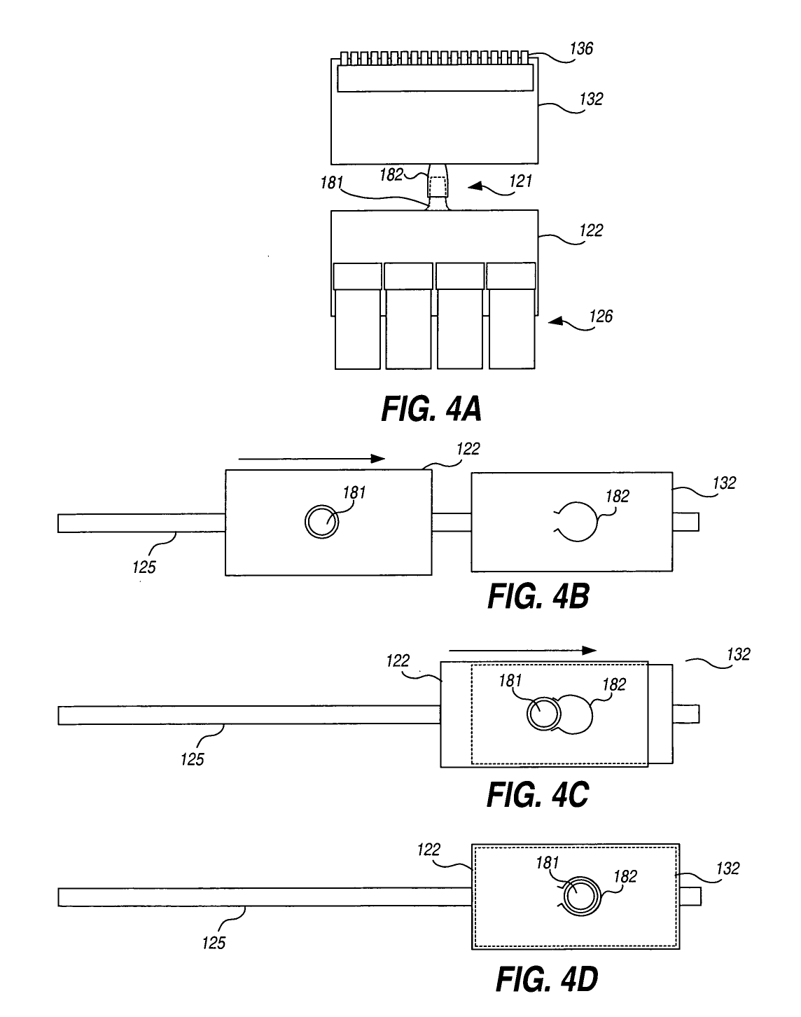

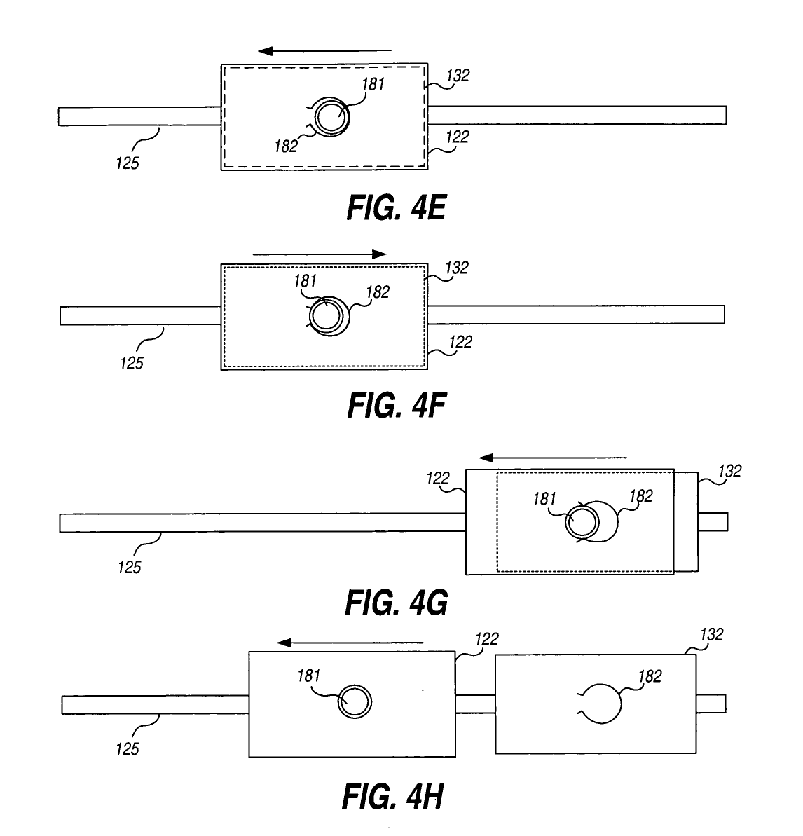

FIG. 4A is a side view of, and FIGS. 4B-4H are cross-sectional top views of an example carriage 122 and scan head 132 connectable via a compression coupling mechanism. In this example, a prong 181 is attached to the top side of carriage 122 and a mating compression c-socket 182 is attached to the bottom side of scan head 132. During a print job, the carriage 122 moves without the scan head 132 (FIG. 4B). When a scan or copy job is required, the carriage 122 is moved towards the scan assembly 130 at high speed so that the force of the prong 181 hitting the mouth of the compression c-socket 182 (FIG. 4C) overcomes the compression force of the c-socket 182, allowing entry and therefore engagement of the prong 181 into the c-socket 182 (FIG. 4D). The carriage movement speed will depend on the specifications including compression force or spring constant of the c-socket 182 and may easily be determined by one skilled in the art through calculations or through a simple trial-and-error process. During scan, the carriage 122 is moved more slowly so as not to disengage the probe 181 from the compression c-socket 182 (FIGS. 4E, 4F). The carriage movement speed with the scan head engaged again will depend on the specifications of the c-socket 182 and may also easily be determined by one skilled in the art through calculations or through a simple trial-and-error process. After the scan function is complete, the carriage 122 is then moved away from the scan assembly 130 at sufficiently high speed so that the force of the prong at the mouth of the c-socket 182 (FIG. 4G) overcomes the compression force of the compression c-socket 182 and therefore disengages the carriage 122 from the scan head 132 (FIG. 4H). Again, the carriage movement speed for overcoming the compression force of the compression c-socket 182 in order to disengage the carriage 122 from the scan head 132 will depend on the c-socket specifications and may easily be determined by one skilled in the art through calculations or through a simple trial-and-error process.

In other embodiments, the attachment link 121 may be a power link whereby a power transmission arrangement is interposed between motor 124 and link 121. In one embodiment, power transmission arrangement includes a coupling 135, such as a clutch, to selectively connect and disconnect the attachment link 121 between the carriage 122 and scan head 132.

In other embodiments, the attachment link 121 may be an electro-mechanical coupling mechanism such as an electromagnet, etc., which relies on movement of the carriage and electronic mechanisms such as electronic relays to engage and disengage the carriage from the scan head.

The carriage motor 124 may optionally be adapted to drive other assemblies in the multiple-function inkjet printing system 100. For example, power from carriage motor 124 may be selectively transmitted to each of the carriage assembly 120 (and therefore also coupled to the scan assembly 130), the media transport assembly 110, and the service station assembly 140, using power transmission arrangements described in detail in the '387 patent, thereby further reducing the number of components, size, and complexity of the multiple-function inkjet printing system.

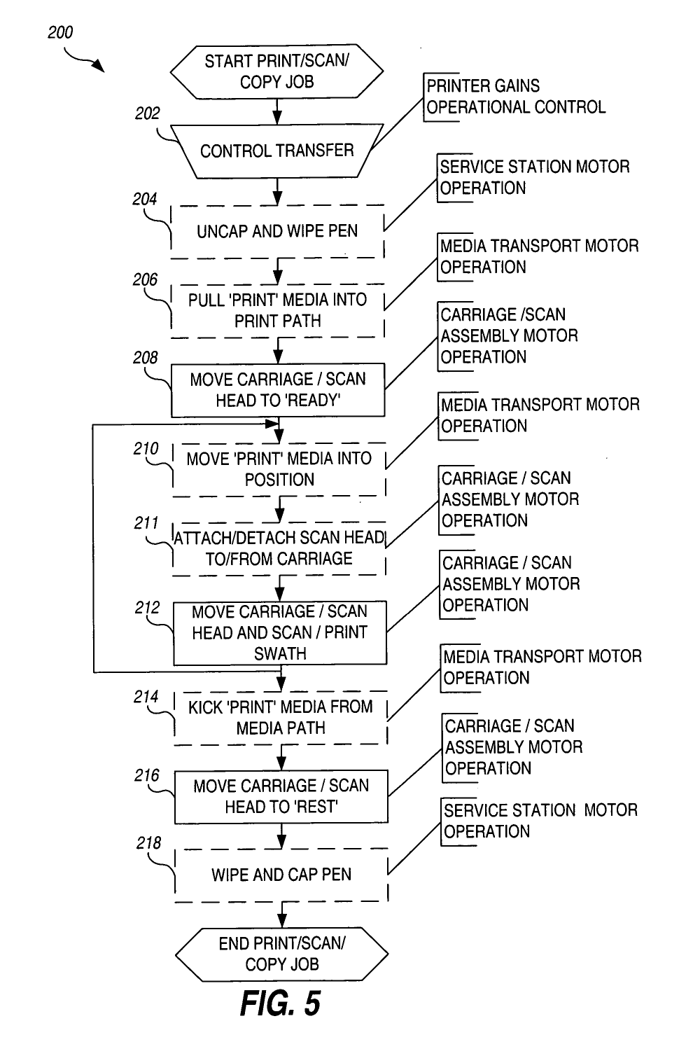

FIG. 5 illustrates one embodiment of a method 200 of operating multiple function inkjet printing system 100 according to the present invention. Initially, multiple function inkjet printing system 200 is in a “Rest” mode of operation. At step 202, multiple function inkjet printing system 100 gains operational control of a print job. At step 204, service station assembly 140 uncaps and wipes print head 126 by operation of the service station motor 142 and, at step 206, the media transport assembly 110 print medium 104 into the print path of the multiple function inkjet printing system 100 by operation of the media transport motor 111.

At step 208, the scan head 132 and carriage 122 are moved to a ‘ready’ position by operation of the carriage/scan assembly motor 124. At step 210, the print medium 104 is advanced by media transport assembly 110. At step 212, the scan head 132 and carriage 122 are moved under operation of the carriage/scan assembly motor 124, and a scan swath is scanned by scan head 132 and a corresponding print swath is printed by print head 126. Steps 210 and 212 are repeated until the print/scan/copy job is completed.

At step 214, scan medium 106 and print medium 104 are kicked from multiple function inkjet printing system 100 by media transport assembly 110 under operation of the media transport motor 111. At step 216, the carriage 122 and scan head 132 are moved to a ‘Rest’ position under operation of the carriage/scan assembly motor 124. At step 218, service station assembly 140 wipes and caps print head 126.

It will be appreciated that all of steps 202 through 218 are performed during a “copy” mode of operation of multiple function inkjet printing system 100 which requires both a “scan” and a “print” operation. During a “print” only mode of operation, the scan media will not be scanned in step 212. During a “scan” only mode of operation, the print media will not be pulled into the media path in step 206 or kicked out of the media path in step 214, nor will the pens print during carriage/scan head movement in step 212. Finally, if the mechanical link 121 is configured with attachment/detachment capability, the carriage assembly 120 will be moved to the scan head and attached by link 121 prior to a “scan” operation, and the carriage assembly 120 will be moved away from the scan head and detached from link 121 prior to a “print” operation, for example in accordance with the description associated with FIGS. 4A-4H.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

Finally, those of skill in the art will appreciate that the invented method and apparatus described and illustrated herein may be implemented in software, firmware or hardware, or any suitable combination thereof. Preferably, the method and apparatus are implemented in software, for purposes of low cost and flexibility. Thus, those of skill in the art will appreciate that the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. It is also possible that other benefits or uses of the currently disclosed invention will become apparent over time.

What is claimed is:

1. A multiple-function printing system, comprising:
a media transport assembly adapted to route a print medium through the multiple-function inkjet printing system;
a carriage assembly adapted to hold a print head assembly and traverse the print medium;
a scan assembly operatively coupled to the carriage assembly and adapted to hold a scan head and traverse a scan medium; and
a motor operatively coupled to and adapted to drive the carriage assembly.

2. The multiple-function printing system of claim 1, wherein:
the scan assembly is fixedly attached to the carriage assembly.

3. The multiple-function printing system of claim 2, wherein:
the carriage assembly and the scan assembly form an integral unit.

4. The multiple-function printing system of claim 1, comprising:
a coupling link configured to removably attach the scan assembly to the carriage assembly.

5. The multiple-function printing system of claim 4, comprising:
a controller which affects attachment of the scan assembly to the carriage assembly by the coupling link for scan operations.

6. The multiple-function printing system of claim 5, wherein:
the controller affects detachment of the scan assembly from the carriage assembly for print operations.

7. A method for constructing a multiple-function printing system, comprising:
providing a media transport assembly adapted to route a print medium through the multiple-function inkjet printing system;
providing a carriage assembly adapted to hold a print head assembly and traverse the print medium;
operatively coupling a scan assembly to the carriage assembly, the scan assembly being adapted to hold a scan head and traverse a scan medium; and
operatively coupling a motor to drive the carriage assembly.

8. The method of claim 7, wherein the step for operatively coupling the scan assembly to the carriage assembly comprises:
fixedly attaching the scan assembly to the carriage assembly.

9. The method of claim 7, wherein the step for operatively coupling the scan assembly to the carriage assembly comprises:
forming the carriage assembly and the scan assembly as an integral unit.

10. The method of claim 7, wherein the step for operatively coupling the scan assembly to the carriage assembly comprises:
providing a coupling link configured to removably attach the scan assembly to the carriage assembly.

11. The method of claim 10, comprising:
providing a controller which affects attachment of the scan assembly to the carriage assembly by the coupling link for scan operations.

12. The method of claim 11, wherein:
the controller affects detachment of the scan assembly from the carriage assembly for print operations.

13. A method of operation for a multiple-function printing system having a media transport assembly adapted to route a print medium through the multiple-function inkjet printing system, a carriage assembly adapted to hold a print head assembly and traverse the print medium, a scan assembly operatively coupled to the carriage assembly and adapted to hold a scan head and traverse a scan medium, and a motor operatively coupled to drive the carriage assembly, comprising the step of:
during a scan operation, causing the motor to drive the carriage assembly to allow the scan assembly attached thereto to scan a swath of the scan media.

14. The method of claim 13, further comprising the step of:
during a scan operation, causing the motor to move the carriage assembly to advance the scan assembly attached thereto.

15. The method of claim 14, further comprising:
during a print operation, causing the motor to drive the carriage assembly to allow the print head assembly to print a swath of the scan media.

16. The method of claim 15, further comprising the step of:
during a print operation, causing the motor to move the carriage assembly to advance the print head assembly.

17. The method of claim 13, further comprising:
during a scan operation, causing the motor to move the carriage assembly to attach the scan assembly to the carriage assembly if the scan assembly is not already attached to the carriage assembly.

18. The method of claim 14, further comprising:
during a scan operation, causing the motor to move the carriage assembly to attach the scan assembly to the carriage assembly if the scan assembly is not already attached to the carriage assembly.

19. The method of claim 13, further comprising:
during a print operation, causing the motor to move the carriage assembly to detach the scan assembly from the carriage assembly if the scan assembly attached to the carriage assembly.

20. The method of claim 14, further comprising:
during a print operation, causing the motor to move the carriage assembly to detach the scan assembly from the carriage assembly if the scan assembly attached to the carriage assembly.
